(19) United States
(12) Patent Application Publication
(10) Pub. No.: US 2024/0380473 A1
(43) Pub. Date: Nov. 14, 2024

(54) METHOD FOR FORMING A COMPOSITE BEAM VIA LINEAR COMBINATION OF ORTHOGONAL BEAMS OF AN ARRAY OF RADIO-COMMUNICATION ANTENNAS

(71) Applicant: ORANGE, Issy-Les-Moulineaux (FR)

(72) Inventors: Corentin FONTENEAU, Chatillon Cedex (FR); Matthieu CRUSSIERE, Chatillon Cedex (FR); Bruno JAHAN, Chatillon Cedex (FR)

(21) Appl. No.: 18/554,427

(22) PCT Filed: Apr. 1, 2022
(86) PCT No.: PCT/FR2022/050619

§ 371 Date: Oct. 6, 2023

(30) Foreign Application Priority Data
Apr. 7, 2021 (FR) 2103569

(51) Int. Cl. H04B 7/06; H04L 5/00; H04L 25/02

(52) U.S. Cl. CPC H04B 7/06966; H04B 7/0626; H04L 5/0051; H04L 5/0094; H04L 25/0204

(57) ABSTRACT

A method of forming a composite beam via linear combination of orthogonal beams of an array of radio-communication antennas. The method of linear combination of orthogonal beams, includes: estimating, for at least one sub-carrier, a propagation channel by means of data collected during a sweeping of the beams, determining a broadband covariance matrix of a multicarrier propagation channel from the estimated propagation channel, selecting an eigenvector of the broadband covariance matrix associated with a highest eigenvalue, a component of the eigenvector corresponding to a weight associated with a beam, determining phase and amplitude modulation coefficients intended to be applied by at least one antenna of an array of antennas according to the components of the eigenvector. The method allows a composite beam that is better adapted to the propagation channel to be formed in the case where a transmitting device and a receiving device are non-line of sight.

### CROSS-REFERENCE TO RELATED APPLICATIONS

This application is filed under 35 U.S.C. § 371 as the U.S. National phase of Application No. PCT/FR2022/050619 entitled “METHOD FOR FORMING A COMPOSITE BEAM VIA LINEAR COMBINATION OF ORTHOGONAL BEAMS OF AN ARRAY OF RADIO-COMMUNICATION ANTENNAS” and filed Apr. 1, 2022, and which claims priority to FR 2103569 filed Apr. 7, 2021, each of which is incorporated by reference in its entirety.

### BACKGROUND

### Field

The field of the development is that of arrays of radio-communication antennas. More specifically, the development relates to a method for forming a composite beam via linear combination of orthogonal beams of an array of radio-communication antennas. This method is particularly useful when a transmitting device and a receiving device are non-line of sight.

### PRIOR ART AND ITS DISADVANTAGES

Linear or planar arrays of antennas are commonly used for radio communications, both in transmission and in reception.

The new mobile communications standards, such as the 5G standard, the fifth generation of mobile telephony standards, propose to use new radio frequency bands such as the millimetre wave, which extends from 30 to 300 GHz.

The use of this millimetre frequency band makes it possible to meet the growing need for data exchange, which is at the heart of the challenges that the 5G standard seeks to solve.

However, the millimetre frequency band has a few disadvantages compared with historic frequency bands, such as greater free-space path losses and greater penetration losses. The use of arrays of radio-communication antennas makes it possible to compensate for free-space path losses by implementing energy focusing techniques.

A conventional technique consists in controlling the transmission or the reception of an array of antennas by means of a linear phase law applied to the signals (referred to as electrical signals as opposed to the radio signal transmitted by an antenna) processed by the various antennas making up the array of antennas in order to focus the energy of the associated radio signal in a desired direction. Such a technique is commonly referred to as beamforming.

Known beamforming techniques are implemented by modulating the amplitude and phase of multi-carrier signals, for example, OFDM in parallel with their processing, i.e. before their transmission or after their reception, by the array of radio-communication antennas. There are essentially two possible implementations of beamforming, commonly referred to as digital and analogue beamforming.

In the case of digital beamforming, each antenna in the array of antennas is associated with its own digital-analogue converter (DAC). The amplitude and phase modulation of OFDM signals can then be carried out on baseband for each sub-carrier and without quantization. This implementation performs well and can significantly increase the signal-to-noise ratio or spectral efficiency, but it is also very costly in terms of hardware design and energy consumption for the frequency band considered, particularly as each analogue-digital converter is associated with one antenna in the array of antennas.

In the case of analogue beamforming, the amplitude and phase modulation of the OFDM signal transmitted by each antenna in the array of antennas is carried out following the generation of the analogue signal by an digital-analogue converter (DAC). For this type of implementation, only one digital-analogue converter is needed, so the number of digital-analogue converters no longer depends on the number of antennas in the array of radio-communication antennas.

Phase and amplitude modulation of the OFDM signal processed by each antenna in the array of antennas is performed using phase shifters and gain-controlled amplifiers respectively. The processing carried out in this way is referred to as broadband because the amplitude and phase modulation cannot be performed per sub-carrier and is therefore the same over the entire frequency band used. Implementing an analogue solution forces the array of antennas to transmit pilot signals (used for estimating the propagation channel) common to the set of antennas comprising the array of antennas. A pilot signal is therefore modulated in amplitude and phase as it is processed in parallel by the antennas of the array of antennas, unlike in a digital implementation where each antenna is associated with its own pilot signal.

The main difficulty, introduced by the use of arrays of radio-communication antenna, is to determine the amplitude and phase modulation to be used at each antenna in order to focus the energy in the most optimal way possible.

A conventional technique for analogue beamforming solutions is to transmit a set of pilot signals in a plurality of directions, each pilot signal being associated with a given transmission direction. A receiving device can thus determine the best pilot resource, in terms of received power, and therefore the most favourable transmission direction for propagating a signal. This technique is commonly referred to as beamsweeping. Such a sweeping technique can be implemented by modifying over time, from one OFDM symbol to another for example, a linear phase shift applied to the pilot signal transmitted by the different antennas in the array of antennas of the transmitting device. In such a sweeping technique on transmission, the amplitude and phase modulation applied to the radio signals received by antennas of an array of antennas of the receiving device is fixed so as to evaluate only the processing applied to the pilot signals prior to their transmission.

These sweeping techniques can also be used on reception. To achieve this, a time-invariant transmission beam, at the scale of a few OFDM symbols for example, is used, while a beamsweeping operation is performed on reception. In this case, no feedback is required as the transmitter does not need to know the reception beam to define the transmission beam.

These techniques are easy to implement and are effective when the transmitting device and the receiving device are in line of sight (LOS), because the amplitude and phase modulations of the signals both on transmission and on reception tend towards a linear phase law, which physically corresponds to the formation of a composite beam pointing in a given direction. It is then sufficient to find the transmission and reception direction using the beamsweeping procedures previously described. When the transmitting device and the receiving device are non-line of sight (NLOS), these techniques have more limited performance because the propagation channel is richer. The amplitude and phase modulations on transmission and on reception no longer tend towards a linear phase law.

There is therefore a need for a beamforming technique that is not only suitable for LOS scenarios but also for NLOS scenarios, and which can determine the amplitude and phase modulation to be used at each antenna in order to focus the energy in the most optimal way possible.

### SUMMARY

The development responds to this need by proposing a method for forming a composite beam via linear combination of orthogonal beams of an array of antennas belonging to a device intended to transmit a radio signal whose energy is focused according to the composite beam, the method comprising the following steps implemented by a device receiving said radio signal:
estimating, for at least one sub-carrier of a frequency band used to transport the radio signal, a propagation channel of the radio signal by means of data collected during a sweeping of the set of orthogonal beams of the array of antennas carried out by said transmitting device,
determining the coefficients of a broadband covariance matrix from the at least one estimated propagation channel,
selecting an eigenvector of said broadband covariance matrix associated with an eigenvalue of said strongest broadband covariance matrix, a component of the selected eigenvector, referred to as weighting vector, corresponding to a weighting coefficient associated with a beam of said array of antennas,
determining parameters relating to phase and amplitude modulation coefficients intended to be applied to at least one signal corresponding to a radio signal processed on transmission by at least one antenna of said array of antennas on the basis of the values of the components of the weighting vector,
transmitting, to the transmitting device, a message comprising said parameters relating to said phase and amplitude modulation coefficients, referred to as feedback message.

Such a method allows a composite beam that is better adapted to the propagation channel to be formed in the case where a transmitting device and a receiving device are non-line of sight.

Indeed, it has been shown that the optimal combination in terms of signal-to-noise ratio SNR is obtained using the eigenvector of the broadband covariance matrix associated with the highest eigenvalue. The principle is applied here to the broadband covariance matrix.

It is then possible to identify the appropriate eigenvector and to deduce, from the values of the components of the identified eigenvector, phase and amplitude modulation coefficients intended to be applied to at least one signal processed by at least one antenna of the array of antennas corresponding to the radio signal in order to form the composite beam.

A such solution does not degrade the performance of LOS-type systems, while improving the performance of NLOS-type systems despite an increased computational complexity.

The transmitting device of the radio signal performs a sweeping of the orthogonal beams formed by its array of antennas and transmits to the receiving device of the radio signal the data collected during the sweeping procedure. This is a sweeping procedure on transmission during which a linear phase shift is applied to the pilot signal transmitted by the various antennas of the array of antennas of the transmitting device.

As the composite beam must be formed by the transmitting device of the radio signal, the receiving device transmits to the transmitting device a message comprising parameters relating to phase and amplitude modulation coefficients to be applied to the signals corresponding to the radio signals intended to be transmitted by the antennas of the array of antennas of the transmitting device in order to generate the composite beam for which the signal-to-noise ratio SNR or the received power is the greatest.

The method for forming can comprise, prior to the step of transmitting said feedback message, the following steps:
creating a subset of beams comprising at least one beam selected from the set of orthogonal beams of said array of antennas,
selecting a weighting vector relating to said subset of beams from a reduced broadband covariance matrix, a component of the weighting vector relating to said subset of beams corresponding to a weighting coefficient associated with a beam of the subset of beams,
determining the values of the components of a quantized weighting vector, said values of the components of said quantized weighting vector being obtained by rounding a value of a modulus and a value of an argument of the components of said weighting vector relating to said subset of beams to at least one possible state defined by a number of quantization bits used to encode the amplitude and phase values,
generating said feedback message, said parameters relating to phase and amplitude modulation coefficients comprising identifiers of the beams included in said subset of beams and said values of the components of the quantized weighting vector.

Generally, the higher the number of bits dedicated to the feedback message, the more the obtained performance tends to be optimal, i.e. the greater is the received power. However, in order to optimise data exchanges between the receiving device and the transmitting device, it is useful to limit the number of bits of the feedback message by limiting the volume of data to be transmitted.

In a first variant, the subset of beams comprises the L beams for which a reception power of the received signal is the greatest.

Thus, only part of the determined data corresponding to the L beams of the subset of beams is transmitted to the transmitting device.

In a second embodiment, the subset of beams comprises the L beams for which a modulus of the corresponding component of the weighting vector relating to said subset of beams is the highest.

Thus, only part of the determined data corresponding to the L beams of the subset of beams is transmitted to the transmitting device.

In a third embodiment, the step of creating the subset of beams comprises the following steps:
a) selecting at least one beam f, from the set of N orthogonal beams formed by the array of antennas, for which a reception power of the radio signal is the highest,
b) determining (N−1) reduced broadband covariance matrices of dimensions 2×2, one reduced broadband covariance matrix of dimensions 2×2 corresponding to a combination of beam f with one of the remaining (N−1) beams,
c) determining the eigenvalues for the set of (N−1) reduced broadband covariance matrices of dimensions 2×2,
d) selecting, from the (N−1) remaining beams, a second beam f corresponding to the eigenvalue of the strongest reduced broadband covariance matrix of dimensions 2×2,
e) steps b) to d) being repeated until a number L of beams are selected to form the subset of beams by increasing by one, at each iteration, the dimensions of the reduced broadband covariance matrix and by decreasing by one, at each iteration, the number of reduced broadband covariance matrices and the number of remaining beams.

Thus, the higher L is, the more the obtained performance tends to be optimal, i.e. the greatest is the received power, because the transmitting device will be able to combine more orthogonal beams together.

This third embodiment variant, like the two previous variants, allows the information returned to the transmitting device to be adapted according to the latter's processing capabilities or according to constraints relating to the environment in which the radio signal propagates.

This third variant offers better performance than the previous two, because the selected L beams are chosen for their ability to combine together correctly to offer greater received power.

The development also relates to a device configured to form a composite beam via linear combination of orthogonal beams of an array of antennas belonging to a device intended to transmit a radio signal whose energy is focused according to the composite beam, the device comprising means for:
receiving said radio signal,
estimating, for at least one sub-carrier of a frequency band used to transport the radio signal, a propagation channel of the radio signal by means of data collected during a sweeping of the set of orthogonal beams of the array of antennas carried out by said transmitting device,
determining coefficients of a broadband covariance matrix from the at least one estimated propagation channel,
selecting an eigenvector of said broadband covariance matrix associated with an eigenvalue of said strongest broadband covariance matrix, a component of the selected eigenvector, referred to as weighting vector, corresponding to a weighting coefficient associated with a beam of said array of antennas,
determining parameters relating to phase and amplitude modulation coefficients intended to be applied to at least one signal corresponding to a radio signal processed in transmission by at least one antenna of said array of antennas according to the values of the components of the weighting vector
transmitting, to the transmitting device, a message comprising said parameters relating to said phase and amplitude modulation coefficients.

The development also relates to a communication device comprising at least one device configured to form a composite beam via linear combination of orthogonal beams of an array of antennas belonging to a device intended to transmit a radio signal whose energy is focused according to the composite beam, the device comprising means for:
receiving said radio signal,
estimating, for at least one sub-carrier of a frequency band used to transport the radio signal, a propagation channel of the radio signal by means of data collected during a sweeping of the set of orthogonal beams of the array of antennas carried out by said transmitting device,
determining coefficients of a broadband covariance matrix from the at least one estimated propagation channel,
selecting an eigenvector of said broadband covariance matrix associated with an eigenvalue of said strongest broadband covariance matrix, a component of the selected eigenvector, referred to as weighting vector, corresponding to a weighting coefficient associated with a beam of said array of antennas,
determining parameters relating to phase and amplitude modulation coefficients intended to be applied to at least one signal corresponding to a radio signal processed in transmission by at least one antenna of said array of antennas according to the values of the components of the weighting vector
transmitting, to the transmitting device, a message comprising said parameters relating to said phase and amplitude modulation coefficients.

In downlink, the radio signal is typically transmitted by a base station, such as an eNodeB for radio-communication networks compliant with the LTE or LTE Advanced standard, or a gNB for radio-communication networks compliant with the 5G standard, and is intended to be received by a user's mobile terminal.

Thus, in downlink, the receiving device is a user's mobile terminal.

In uplink, the radio signal is typically transmitted by a user's mobile terminal and is intended to be received by a base station, such as an eNodeB for radio-communication networks compliant with the LTE or LTE Advanced standard, or a gNB for radio-communication networks compliant with the 5G standard.

Thus, in uplink, the receiving device is a base station.

The development also proposes a method for generating a composite beam via linear combination of orthogonal beams of an array of antennas belonging to a device intended to transmit a radio signal whose energy is focused according to the composite beam, said method being implemented by the transmitting device and comprising the following steps:
sweeping, for at least one sub-carrier of a frequency band used to transport the radio signal, the set of orthogonal beams of said array of antennas,
transmitting data collected during the sweeping of the set of orthogonal beams to a device intended to receive the radio signal,
receiving a message transmitted by the receiving device, said message comprising parameters relating to phase and amplitude modulation coefficients intended to be applied to at least one signal corresponding to a radio signal processed in transmission by at least one antenna of said array of radio-communication antennas, said modulation coefficients being determined according to values of the components of an eigenvector of a broadband covariance matrix whose coefficients are determined on the basis of an estimate of a propagation channel obtained by means of the data collected during the sweeping of the set of orthogonal beams, said eigenvector being associated with an eigenvalue of said strongest broadband covariance matrix, a component of the eigenvector constituting a weighting coefficient associated with a beam of the array of antennas,
modulating said at least one signal corresponding to the radio signal processed in transmission by at least one antenna of said array of antennas by means of said parameters relating to received phase and amplitude modulation coefficients.

Such a method is implemented by the device transmitting the radio signal, which sweeps the beams generated by its own array of antennas. In order to be able to generate the composite beam offering a high reception power to the receiving device of the radio signal, the transmitting device must have parameters relating to phase and amplitude modulation coefficients intended to be applied to at least one signal processed by at least one antenna of its array of antennas corresponding to the radio signal provided to it by the receiving device.

As a corollary, a purpose of the development is a communication device configured to generate a composite beam via linear combination of orthogonal beams of an array of antennas belonging to said communication device, said communication device intended to transmit a radio signal whose energy is focused according to the composite beam, the communication device comprising means for:
sweeping, for at least one sub-carrier of a frequency band used to transport the radio signal, the set of orthogonal beams of said array of antennas,
transmitting data collected during the sweeping of the set of orthogonal beams to a device intended to receive the radio signal,
receiving a message transmitted by the receiving device, said message comprising parameters relating to phase and amplitude modulation coefficients intended to be applied to at least one signal corresponding to a radio signal processed in transmission by at least one antenna of said array of radio-communication antennas, said modulation coefficients being determined on the basis of values of the components of an eigenvector of a broadband covariance matrix whose coefficients are determined on the basis of an estimate of a propagation channel obtained by means of the data collected during the sweeping of the set of orthogonal beams, said eigenvector being associated with an eigenvalue of said strongest broadband covariance matrix, a component of the eigenvector constituting a weighting coefficient associated with a beam of the array of antennas,
modulating said at least one signal corresponding to the radio signal processed in transmission by at least one antenna of said array of antennas by means of said parameters relating to phase and amplitude modulation coefficients received.

In downlink, the radio signal is typically transmitted by a base station, such as an eNodeB for radio-communication networks compliant with the LTE or LTE Advanced standard, or a gNB for radio-communication networks compliant with the 5G standard, and is intended to be received by a user's mobile terminal.

Thus, in downlink, the transmitting device is a base station.

In uplink, the radio signal is typically transmitted by a user's mobile terminal and is intended to be received by a base station, such as an eNodeB for radio-communication networks compliant with the LTE or LTE Advanced standard, or a gNB for radio-communication networks compliant with the 5G standard.

Thus, in uplink, the transmitting device is a user terminal.

Finally, the development relates to computer program products comprising program code instructions for implementing the methods as described previously, when they are executed by a processor.

The development also relates to a computer-readable storage medium on which are saved computer programs comprising program code instructions for implementing the steps of the methods according to the development as described above.

Such a storage medium can be any entity or device able to store the programs. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer programs contained therein are executed remotely. The programs according to the development can be downloaded in particular on a network, for example the Internet network.

Alternatively, the storage medium can be an integrated circuit in which the programs are embedded, the circuit being adapted to execute or to be used in the execution of the above-mentioned methods covered by the development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1 shows the array factor obtained for beam steering angle Φₘ=−14.48° for an array of antennas comprising (N+1)=8 antennas,

FIG. 2 shows the orthogonal beams f₁ to f_{N} for an array of antennas comprising 8 antennas,

FIG. 3 shows the steps of the methods for forming and generating a composite beam via linear combination of orthogonal beams of an array of antennas of a communication device according to the development,

FIG. 4 shows a first embodiment of the methods for forming and generating a composite beam according to the development,

FIG. 5 shows a second embodiment of the methods for forming and generating a composite beam according to the development,

FIG. 6 shows the results of applying a state-of-the-art method for forming a composite beam and of methods for forming and generating a composite beam to a transmitting device EE-receiving device ER pair that are non-line of sight,

FIG. 7 shows the performance obtained following the application of the second embodiment of the solution according to the development,

FIG. 8 shows the performance obtained following the application of the second embodiment of the solution according to the development,

FIG. 9 shows the performance obtained following the application of the second embodiment of the solution according to the development,

FIG. 10 shows the performance obtained following the application of the first embodiment of the solution according to the development,

FIG. 11 shows the performance obtained following the application of the first embodiment of the solution according to the development,

FIG. 12 figure shows the degradation of performance due to phase quantization for the WL-PO method and due to amplitude and phase quantization for the WL method,

FIG. 13 shows a device capable of implementing the methods covered by the development,

FIG. 14 shows the device connected to a phase modulator of an antenna of the array of antennas.

### DETAILED DESCRIPTION OF CERTAIN ILLUSTRATIVE EMBODIMENTS

The general principle of the development is based on the formation of a composite beam via linear combination of orthogonal beams of an array of antennas of a communication device by determining the combination of orthogonal beams which makes it possible to offer a high value of reception power of a radio signal whose energy is focused according to the composite beam. To achieve this, the development proposes to determine parameters relating to phase and amplitude modulation coefficients intended to be applied to signals processed by the antennas of the considered array of antennas corresponding to the radio signal in order to form the appropriate composite beam according to a broadband covariance matrix of the multi-carrier propagation channel of the radio signal. Such a solution allows a high reception power of the radio signal to be provided even when the transmitting device of the radio signal and the device receiving it are non-line of sight.

More specifically, the development is based on the use of the method referred to as the Woodward Lawson method combined with the search for a main component of an estimate of a multi-carrier propagation channel.

The Woodward-Lawson method enables to form a composite beam from a linear combination of orthogonal beams following a linear phase law. The shape of a beam generated by an array of antennas is characterised by the array factor. The array factor AF(θ,Φ) of an array of antennas oriented according to the axis \vec{y} is given by:

$$AF ( θ , ϕ ) = {\sum }_{n = 1}^{N + 1} {j}_{n} {e}^{{jk}_{0} {y}_{n} sin θ sin ϕ} \qquad ( 1 )$$

where (N+1), k₀, iₙ and yₙ correspond respectively to the number of antennas making up the array of radio-communication antennas, the wave number, the excitation of the n^{th} antenna and the position of the n^{th} antenna. In the case of a power-normalised linear phase excitation, in is written:

$${i}_{n} = \frac{1}{\sqrt{( N + 1} )} {e}^{- {ik}_{0} {y}_{n} sin {ϕ}_{m}} \qquad ( 2 )$$

where Φₘ is the beam steering angle of the beam in azimuth. From equations (1) and (2), the radiation can be rewritten as follows:

$${AF}_{LPE} ( θ , ϕ , {ϕ}_{m} ) = \frac{sin [ \frac{( N + 1 )}{2} {k}_{0} d ( sin θ sin ϕ - sin {ϕ}_{m} ) ]}{\sqrt{( N + 1 )} sin [ \frac{1}{2} {k}_{0} d ( sin θ sin ϕ - sin {ϕ}_{m} ) ]} \qquad ( 3 )$$

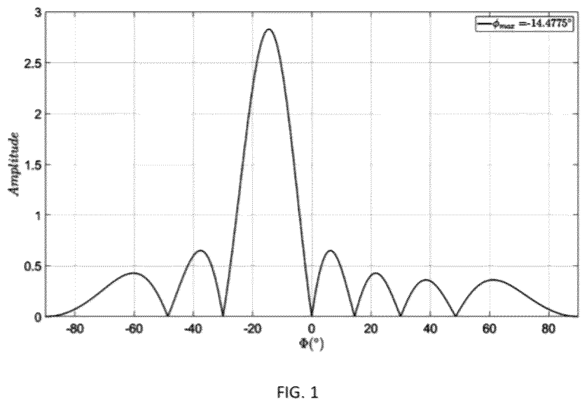

FIG. 1 shows the array factor obtained via linear phase excitation for a beam steering angle Φₘ=−14.48° for an array of antennas comprising (N+1)=8 antennas.

The Woodward-Lawson method proposes to construct a composite beam from a linear combination of orthogonal beams following a linear phase law. The orthogonality of the beams is ensured by choosing Φₘ such that:

$${ϕ}_{m} = a sin ( \frac{2 m}{N + 1} ) , \qquad ( 4 )$$

$$m ∈ [ - M ; M ]$$

$$with$$

$$m ∈ ℤ .$$

$$Where$$

$$M = \frac{( N + 1 )}{2} - 1 .$$

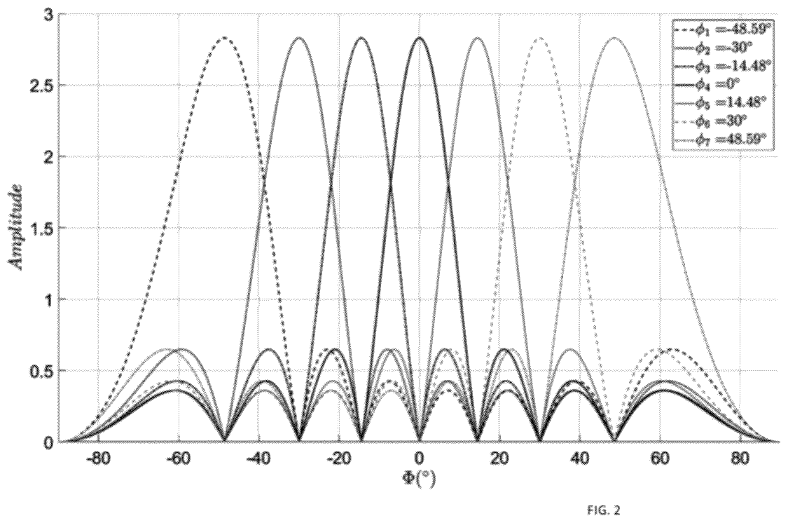

As an example, the orthogonal beams f₁ to f_{N} for an array of antennas comprising 8 antennas are shown in FIG. 2. The orthogonality of the beams is visually verified by the presence of zero radiation values at the radiation maximum of each beam.

The Woodward-Lawson beam AF_{WL}(θ,Φ) is finally formed by linearly combining the orthogonal beams as follows:

$${AF}_{WL} ( θ , ϕ ) = {\sum }_{m = - M}^{M} {b}_{m} \times {AF}_{LPE} ( θ , ϕ , {ϕ}_{m} ) \qquad ( 5 )$$

where bₘ is the complex weighting coefficient associated with each orthogonal beam.

The amplitude and phase modulation i_{WL,n} to be applied to the n^{th} antenna of the array of antennas to obtain AF_{WL}(θ,Φ) is given by:

$${i}_{WL , n} = \frac{1}{\sqrt{( N + 1 )}} {\sum }_{m = - M}^{M} {b}_{m} {e}^{- {ik}_{0} {y}_{n} sin {ϕ}_{m}} , \qquad ( 6 )$$

$$n ∈ [ 1 ; ( N + 1 ) ]$$

$$and$$

$$n ∈ ℕ .$$

The search for the main component of the multi-carrier propagation channel is used to determine the complex coefficient bₘ associated with each beam in order to maximise the power received by the receiving device of the radio signal.

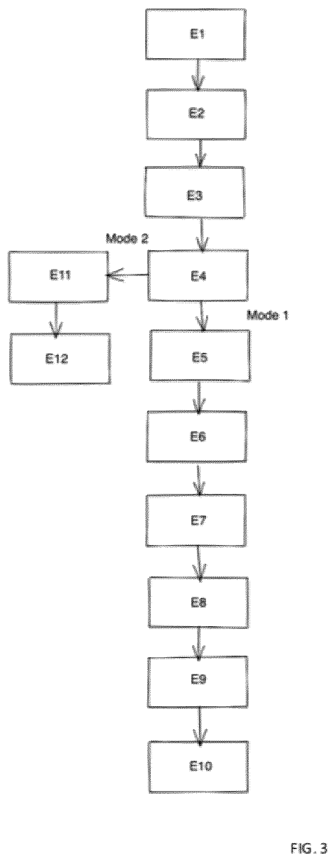

In relation to FIG. 3, the steps of the methods for forming and generating a composite beam via linear combination of orthogonal beams of an array of antennas of a communication device according to the development are now presented.

In a first step E1, a sweeping of the set of N orthogonal beams f₁ to f_{N} of the array of antennas of a communication device E is performed for at least one sub-carrier of a used frequency band, on baseband, to transport the radio signal.

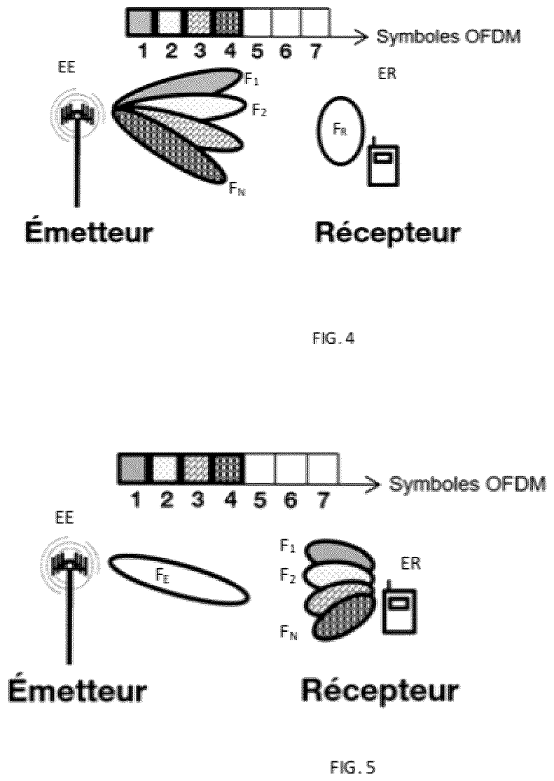

In a first embodiment illustrated in FIG. 4, the sweeping is performed by the transmitting device EE of the radio signal.

Such a sweeping technique consists of transmitting pilot signals in a set of directions, where each pilot signal is associated with a transmission direction and where a transmission direction corresponds to one of the beams f₁ to f_{N}.

To achieve this, the transmitting device EE modifies over time, from one OFDM symbol to the other for example, the linear phase shift applied to the pilot signals transmitted by the different antennas of the array of antennas of the transmitting device EE.

During the sweeping performed by the transmitting device EE, the amplitude and phase modulation applied to the signal, corresponding to the radio signal received by the antennas of the array of antennas of the receiving device ER, is fixed so as to evaluate only the processing applied by the transmitting device EE, which means forming a single beam f_{R}. The receiving device ER can thus determine the best beam, in terms of received power, and therefore the most favourable transmission direction for the propagation of the radio signal.

In a second embodiment illustrated in FIG. 5, the sweeping is performed by the receiving device ER of the radio signal.

Such a sweeping technique consists in receiving pilot signals in a set of directions, where each received pilot signal is associated with a reception direction and where a reception direction corresponds to one of the beams f₁ to f_{N}.

To achieve this, the receiving device ER modifies over time, from one OFDM symbol to the other for example, the linear phase shift applied to the pilot signals received by the different antennas of the array of antennas of the receiving device ER.

During the sweeping performed by the receiving device ER, the amplitude and phase modulation applied to the signal corresponding to the radio signal transmitted by the antennas of the array of antennas of the transmitting device EE is fixed so as to evaluate only the processing applied by the receiving device ER, which means forming a single beam f_{E}. The receiving device ER can thus determine the best reception beam, in terms of received power.

Whether in the first embodiment or the second embodiment, the beam sweeping is performed for the set of sub-carriers of a used frequency band, on baseband, to transport the radio signal.

In a step E2, the receiving device ER estimates, for the various sub-carriers k in the frequency band used to transmit the radio signal, a propagation channel of the radio signal.

Since only one pilot signal is transmitted over the duration of an OFDM symbol, only one of the N orthogonal beams is evaluated per OFDM symbol, so the sweeping procedure performed in step E1 extends over as many OFDM symbols as there are beams to be evaluated. In the proposed implementation, if the transmitting device EE performing the beam sweeping comprises (N+1) antennas, N OFDM symbols are required to estimate the propagation channel using the set of orthogonal beams whose phase laws are defined by equations (2) and (4).

Thus, for a k-index OFDM sub-carrier, the channel hₖ∈ [symbol] ^{N} estimated on baseband by the receiving device ER, after the beam sweeping procedure, is expressed as:

$${h}_{k} = [ {h}_{k , 1} , {h}_{k , 2} , … , {h}_{k , n} , … , {h}_{k , N} ] \qquad ( 7 )$$

where k is the index of sub-carrier t and n is the OFDM symbol index. Here, k∈{1, . . . . K}, where K is a natural integer representing the total number of sub-carriers in the frequency band used to transmit the radio signal.

In a step E3, the receiving device ER determines a broadband covariance matrix of a multi-carrier propagation channel of the radio signal from the different propagation channels estimated for the set of k sub-carriers of the frequency band used to transmit the radio signal.

If it is considered that all orthogonal f_{N} beams have been tested during the sweeping procedure, the broadband covariance matrix R∈ [symbol] ^{(N)×(N)} is calculated as follows:

$$R = {\sum }_{k = 1}^{K} {h}_{k}^{H} {h}_{k} \qquad ( 8 )$$

where K is the number of sub-carriers in the frequency band used to transmit the radio signal.

In a step E4, the receiving device ER selects an eigenvector of the broadband covariance matrix from the set of eigenvectors of the broadband covariance matrix.

The eigenvector thus selected is the eigenvector associated with the highest eigenvalue of the broadband covariance matrix. Indeed, for a given sub-carrier k, it has been shown that the optimal combination in terms of signal-to-noise ratio SNR is obtained using the eigenvector of the broadband covariance matrix associated with the highest eigenvalue. The principle is generalised here to the broadband covariance matrix R i.e. for the whole band. Thus, the weighting vector b_{opt∈} [symbol] ^{N} of the orthogonal beams is obtained by calculating:

$${b}_{opt} = eig ( R ) \qquad ( 9 )$$

where eig( ) is the operator symbolising the calculation of the eigenvectors followed by the selection of the eigenvector associated with the highest eigenvalue.

In the first embodiment of the development, as the composite beam must be formed by the transmitting device EE the radio signal, the receiving device ER must transmit to the transmitting device EE parameters relating to phase and amplitude modulation coefficients to be applied to the signals corresponding to the radio signals intended to be transmitted by the antennas of the array of antennas of the transmitting device EE in order to generate the composite beam for which the signal-to-noise ratio SNR is the highest.

To this end, the receiving device ER determines parameters relating to phase and amplitude modulation coefficients intended to be applied to at least one signal processed by at least one antenna of the array of antennas of the transmitting device EE and corresponding after transmission to the radio signal.

Thus, in a step E5, the receiving device ER creates a subset of L beams comprising at least one beam selected from the set N of orthogonal beams of the array of antennas of the transmitting device EE.

In a first implementation, the L beams selected to be part of the subset of beams are the beams for which the received power of the radio signal is the highest. The received power associated with each beam is given by the diagonal of the broadband covariance matrix R.

In a second implementation, the modulus of the components of the weighting vector bₒₚₜ is calculated. The indexes 1 to N of the L components with the highest modulus correspond to the L beams f_{N} selected to form the subset of beams.

In a third implementation, an f-index beam, f∈(1, . . . , N), associated with the highest power received by the receiving device ER is selected.

In an example where L=2, the receiving device ER determines N−1 broadband covariance matrices R_{fi}∈ [symbol] ^{2×2} where f is the index of the beam associated with the highest power and where i∈{1; 2; . . . ; N}\{f}. The broadband covariance matrices R_{fi} are obtained from the broadband covariance matrix R by selecting the f and i-index rows and columns.

The receiving device ER then calculates the eigenvectors of the N−1 broadband covariance matrices R_{fi}.

The i-index beam selected to be combined with the f-index beam to form the composite beam is the one for which the eigenvalue of the broadband covariance matrix R_{fi} is the highest among the set of eigenvalues of the N−1 broadband covariance matrices R_{fi}.

This process is repeated again if L=3 with R_{fij}∈ [symbol] ^{3×3} where f and i are known and where j∈{1; 2; . . . ; N}\{f,i}. After calculating the eigenvalues of the R_{fij} matrices, the j-index beam selected to be combined with the f-index beam and the i-index beam to form the composite beam is the one for which the eigenvalue of the broadband covariance matrix R_{fij} is the highest among the set of eigenvalues of the N−2 broadband covariance matrices R_{fij}. The process is repeated as many times as necessary according to the value of L.

Once the subset of L beams has been created, the receiving device ER calculates, in a step E6, a complex weighting b_{sub-opt}∈ [symbol] ^{N} of the selected L orthogonal beams.

To do this, the receiving device ER determines a broadband covariance matrix R_{reduced}∈ [symbol] ^{L×L} by selecting the L rows and columns of the broadband covariance matrix R associated with the beams selected in step E6. The weight vector b_{reduced sub-opt}∈ [symbol] ^{L} is obtained by calculating the eigenvectors of the broadband covariance matrix R_{reduced} and selecting the eigenvector associated with the highest eigenvalue of the broadband covariance matrix R_{reduced}. The weighting vector b_{sub-opt} is finally obtained by creating a vector of dimension N whose components correspond to the components of the weighting vector b_{reduced sub-opt} for the indexes corresponding to those of the L beams selected.

In a step E7, the receiving device ER quantifies in amplitude and phase the components of the weighting vector b_{sub-opt}. The number of quantization bits associated with the amplitude and phase defines the number of possible states. The number of quantization bits is determined by the maximum size that one wants to apply to the feedback message.

In the case where N_{A} bits and N_{P} bits are used for amplitude and phase quantization respectively, 2^{N}^{_{A}} and 2^{N}^{_{P}} states are possible. Such possible states correspond to a number of configurable values, at the gain-controlled amplifier and at phase shifter respectively. Amplitude and phase quantization is performed by rounding the modulus and argument of the complex weights of the components of the weighting vector b_{sub-opt} to the nearest possible states. The quantified weighting vector thus obtained is noted bₛₒᵤₛ₋ₒₚₜ^{q}.

Finally, in a step E8, the receiving device generates a feedback message intended to be transmitted to the transmitting device EE. This feedback message is composed of N bits identifying the L selected beams and of L (N_{A}+N_{P}) bits representing the amplitude and phase weightings associated with each selected beam and determined in step E8. Generally speaking, the greater is the number of bits in the feedback message, the more the obtained performance in terms of received power of the radio signal tends to be optimal.

In a step E9, the transmitting device EE calculates the amplitude and phase modulation i_{WL,n} with n∈{1; 2; . . . ; (N+1)} to be applied to the (N+1) antennas of the array of antennas from equation (6) by means of the information included in the feedback message generated in step E9. The component bₘ corresponds to the m^{th} element of the weighting vector bₛₒᵤₛ₋ₒₚₜ^{q}.

If the control of the array of antennas of the transmitting device EE is performed only using phase shifters, a phase law must be calculated from the amplitude and phase law determined from equation (6).

The phase law i_{WL-PO}∈ [symbol] ^{N} with

$$\vert {i}_{WL - PO , n} \vert = \frac{1}{\sqrt{( N + 1 )}}$$

can be calculated directly, according to two methods, keeping only the argument of i_{WL}.

According to a first method which consists in keeping only the argument of the components of the vector defining the amplitude and phase law in order to form the phase law, the phase law i_{WL-PO} is given by:

$${i}_{WL - PO} = arg ( {i}_{WL} ) \qquad ( 10 )$$

The second method consists in finding the phase law that minimises the error between the beam formed by the phase and amplitude law and the beam formed by the phase law. To be solved, this problem requires the use of an optimisation algorithm. According to this second method, the phase law i_{WL-PO} is given by:

$${i}_{WL - PO} = arg mi {‖ {AF}_{WL} - {AF}_{WL - PO} ( ) ‖}_{F} \qquad ( 11 )$$

where AF_{WL} is the array factor obtained from the amplitude and phase excitation i_{WL} and AF_{WL-PO} is the array factor obtained with phase excitation.

The results show that performance is the same for both solutions. However, the first method is much less costly to calculate than the second.

Finally, in a step E10, the transmitting device EE modulates the signal corresponding to the radio signal intended to be transmitted by the antennas of the array of antennas of the transmitting device EE in amplitude and phase by means of the excitation coefficients i_{WL,n} obtained in step E9. The excitation coefficients i_{WL,n} can be rewritten in exponential form, which allows to separate the amplitude command Aₙ from the phase command Φₙ:

$${i}_{WL , n} = {A}_{n} {e}^{j {Φ}_{n}} \qquad ( 12 )$$

$$where$$

$${A}_{n} = \vert {i}_{WL , n} \vert \qquad ( 13 )$$

$$and$$

$${Φ}_{n} = arg ( {i}_{WL , n} ) \qquad ( 14 )$$

where Aₙ and Φₙ correspond respectively to a command at an amplifier and at a phase shifter for the n^{th} antenna of the radio communication network of the transmitting device EE.

In the second embodiment of the development, the composite beam is formed by the receiving device ER.

Thus, in a step E11 consecutive to step E5, the receiving device ER calculates the amplitude and phase modulation i_{WL,n} with n∈{1; 2; . . . ; (N+1)} to be applied to the (N+1) antennas of the array of antennas of the receiving device ER from equation (6). The bₘ component corresponds to the m^{th} element of the weighting vector bₒₚₜ.

If the control of the array of antennas of the receiving device ER is performed only using phase shifters, a phase law must be calculated from the amplitude and phase law determined from equation (6). The phase law i_{WL-PO}∈ [symbol] ^{N} with

$$\vert {i}_{WL - PO , n} \vert = \frac{1}{\sqrt{( N + 1 )}}$$

can be calculated directly, keeping only the i_{WL} argument according to one of the two methods described above:

$${i}_{WL - PO} = arg ( {i}_{WL} ) \qquad ( 10 )$$

$$or$$

$${i}_{WL - PO} = arg mi {‖ {AF}_{WL} - {AF}_{WL - PO} ( ) ‖}_{F} \qquad ( 11 )$$

where AF_{WL} is the array factor obtained from the amplitude and phase excitation i_{WL} and A_{FWL-PO} is the array factor obtained with phase excitation.

Finally, in a step E12, the receiving device ER modulates the signal corresponding to the radio signal by the antennas of the array of antennas of the receiving device ER in amplitude and phase by means of the excitation coefficients i_{WL,n} obtained in step E11. The excitation coefficients i_{WL,n} can be rewritten in exponential form, which allows to separate the control in amplitude Aₙ from the phase control Φₙ:

$${i}_{WL , n} = {A}_{n} {e}^{j {Φ}_{n}} \qquad ( 12 )$$

$$where$$

$${A}_{n} = \vert {i}_{WL , n} \vert \qquad ( 13 )$$

$$and$$

$${Φ}_{n} = arg ( {i}_{WL , n} ) \qquad ( 14 )$$

where Aₙ and Φₙ correspond respectively to a command at an amplifier and at a phase shifter for the n^{th} antenna of the radio-communication network of the receiving device ER.

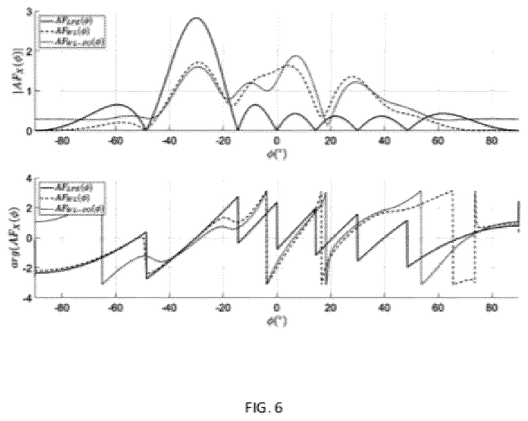

As an example, the results of applying a state-of-the-art method for forming a composite beam and of methods for forming and generating a composite beam to a transmitting device EE—receiving device ER pair that are non-line of sight are shown in FIG. 6.

In this FIG. 6, the array factor AF_{LPE}(Φ) is obtained by selecting the best linear phase law according to the state-of-the-art method, and the array factors AF_{WL}(Φ) and AF_{WL-PO} (Φ) are obtained by applying the solution covered by the present development considering respectively a phase and amplitude excitation and a phase excitation only.

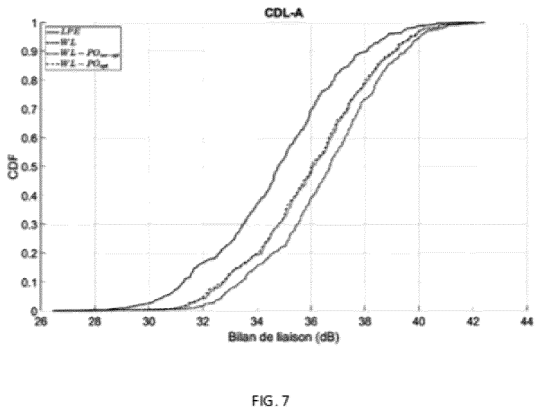

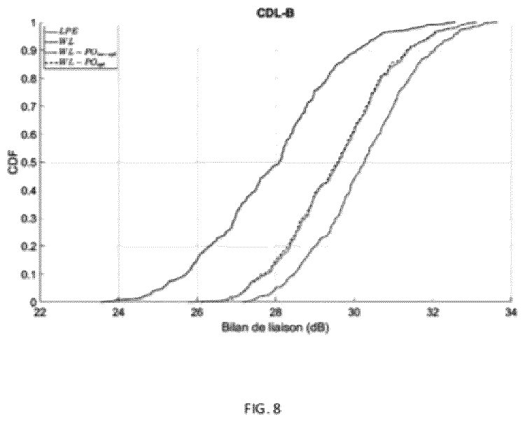

The performance obtained following the application of the second embodiment of the solution according to the development is shown in FIG. 7, FIG. 8, and FIG. 9 for three types of environment. These results were obtained considering an OFDM transmission with a central frequency f_{c}=30 GHz, an inter-sub-carrier deviation Δᵣ=60 kHz and a frequency band B=200 MHz. The estimation of the propagation channels hₖ is considered to be perfect.

CDL-A and B correspond to NLOS environments (“Indoor” and “Urban Micro” respectively), while CDL-D corresponds to a LOS environment.

An “Urban Micro” environment is an environment in which the height of the base station antenna and that of a user terminal are assumed to be much below the tops of the surrounding buildings. The two antennas are supposed to be located outside, in an area where the streets are laid out in a grid similar to that of Manhattan, for example. The streets within the coverage area are classified as “the main street”, where there is line-of-sight from all locations to the base station, except where line-of-sight is temporarily blocked by traffic (e.g. lorries and buses) on the street. Streets that cross the main street are called perpendicular streets, and those that run parallel to it are called parallel streets. This scenario is defined for the Los and NLOS cases. The shapes of the communication network cells are defined by the surrounding buildings, and the energy reaches the NLOS streets as a result of propagation around corners, through buildings and between them.

In the rest of the document, it is assumed that the transmitting device EE and receiving device ER are in an NLOS environment.

Aₙ array of antennas composed of 256 antennas (16×16 configuration) on transmission and an array of 8 antennas (8×1 configuration) on reception are used. The antennas of the array of antennas of the transmitting device EE have a gain of 8 dBi and a 3 dB aperture of 65° and the antennas in the array of antennas of the receiving device ER have a gain of 5 dBi and a 3 dB aperture of 90°. The array of antennas of the transmitting device EE focuses the OFDM signal in a direction favourable to propagation using a linear phase law, while the array of antennas of the receiving device ER implements the solution covered by the development.

The metric used characterises the total gain provided by the use of arrays of radio-communication antennas on transmission and on reception compared to a solution which would consist of using an omnidirectional antenna on transmission and on reception. In the rest of the document, this metric is referred to as the link budget. The link budget distribution functions are shown in FIGS. 7 to 10 and can be used to characterise the statistical efficiency of different reception processes.

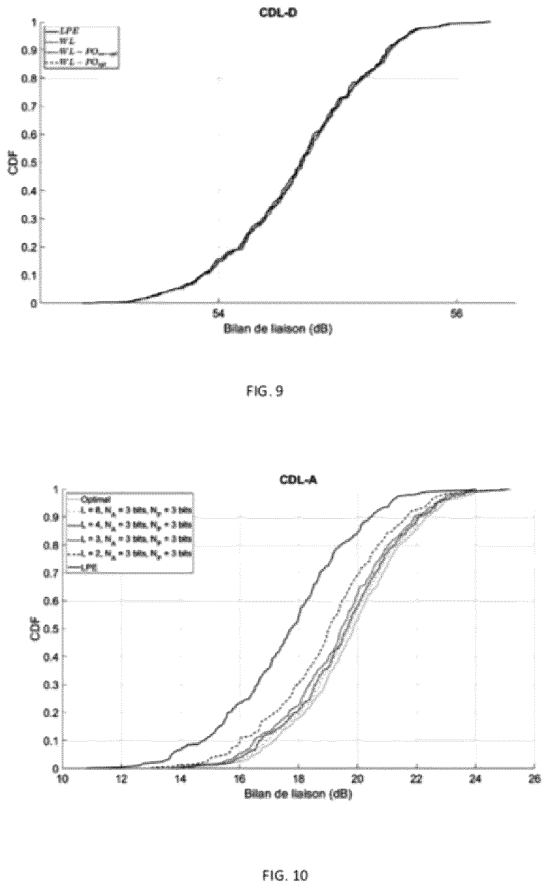

The LPE method corresponds to conventional beam sweeping with selection of the best beam. The WL, WL-POₙₒ₋ₒₚₜ and WL-POₒₚₜ methods correspond to the solution according to the development. The OFDM signals are modulated in phase and amplitude for the first and only in phase for the next two, without optimisation for FIG. 9 and with optimisation for FIG. 10.

If the array of antennas used enables to control the amplitude and phase of the OFDM signal at each antenna (WL), it can be seen that the method proposed in this patent application provides an average gain of just under 2 dB in a CDL-A environment and above 2 dB in a CDL-B environment compared to the state-of-the-art method that consists in selecting the best linear phase law (LPE) beam.

If the signal is modulated only in phase (WL-POₙₒ₋ₒₚₜ and WL-POₒₚₜ), a degradation of approximately 0.5 dB and 0.7 dB (CDL-A and B respectively) is received compared to a radio-communication network that can modulate the signal in amplitude and phase (WL). Thus, the method according to the development does not introduce any losses in a CDL-D (LOS) environment. It can also be noticed that the optimisation method (WL-POₒₚₜ) does not provide any gain (compared to WL-POₙₒ₋ₒₚₜ) for the tested environments. The performance obtained following the application of the first embodiment of the solution according to the development is shown in FIG. 9 and FIG. 10 for the two NLOS environments.

These results were obtained considering an OFDM transmission with a central frequency f_{c}=30 GHz, an inter-sub-carrier deviation Δᵣ=60 kHz and a frequency band B=200 MHz. The estimation of the propagation channels hₖ is considered to be perfect.

An array of antennas composed of 16 antennas (16×1 configuration) on transmission and an array of 8 antennas (8×1 configuration) on reception are used. The antennas of the array of antennas of the transmitting device EE have a gain of 8 dBi and a 3 dB aperture of 65° and the antennas in the array of antennas of the receiving device ER have a gain of 5 dBi and a 3 dB aperture of 90°. The array of antennas of the transmitting device EE implements the first embodiment of the development (WL) while the array of antennas of the receiving device ER employs the Woodward-Lawson method in such a way as to form an expanded beam.

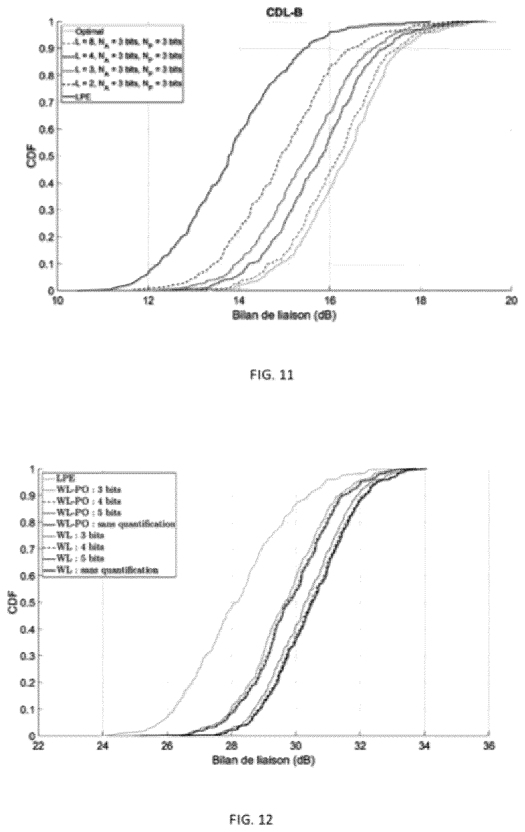

The link budget distribution functions are shown in FIG. 10 and FIG. 11 and allow to characterise the statistical efficiency of the solution covered by the development according to the feedback provided. In all cases, beam selection is carried out using the third implementation of the first embodiment as it is the most efficient in terms of link budget.

The LPE method corresponds to a conventional beamsweeping on transmission with selection of the best beam. The solution covered by the development is implemented by considering a feedback carried out on 3 bits for amplitude and 3 bits for phase for each beam, where the number of beams is L={2; 3; 4; 8}. The optimum is obtained by considering that the weighting vector bₒₚₜ is used on transmission to calculate the amplitude and phase modulation to be applied to a signal corresponding to the signal intended to be transmitted by each antenna of the array of antennas of the transmitting device EE. It can be seen that a feedback on 2 beams leads to a statistically significant gain of more than 1 dB for the two types of environment considered. The higher L is, the more efficient the solution. However, the feedback is more costly in terms of the number of bits used.

In the case of an actual implementation, the amplitude and phase modulation is quantified in order to respect the constraints imposed by the use of analogue phase shifters and gain-controlled amplifiers. The following results are obtained by considering the second embodiment of the development with the same parameters as those described for FIG. 8. The performance degradation due to phase quantization for the WL-PO method and due to amplitude and phase quantization for the WL method is shown in FIG. 12.

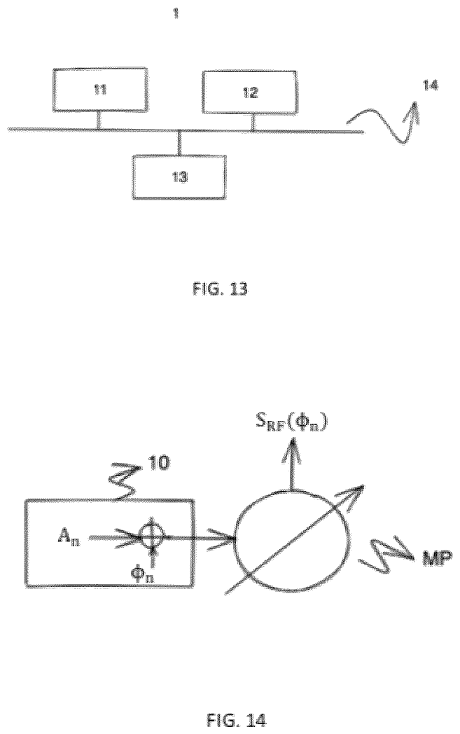

FIG. 13 shows a device 1 capable of implementing the methods described in reference to FIG. 3.

A device 1 may comprise at least one hardware processor 11, a storage unit 12 and at least one network interface 13, which are connected to each other via a bus 14. Naturally, the components of the device 1 can be connected by means of a connection other than a bus.

The processor 11 controls the operations of the device. The storage unit 12 stores at least one program for implementing the method according to an embodiment to be executed by the processor 11, and various data, such as parameters used for calculations performed by the processor 11, intermediate data for calculations performed by the processor 11, etc. The processor 11 may be formed by any known and appropriate hardware or software, or by a combination of hardware and software. For example, the processor 11 can be formed by a dedicated hardware such as a processing circuit, or by a programmable processing unit such as a Central Processing Unit which executes a program stored in a memory thereof.

The storage unit 12 may be formed by any appropriate means capable of storing the program or programs and data in a computer-readable manner. Examples of storage devices 12 include non-transitory computer-readable storage media such as semiconductor memory devices, and magnetic, optical or magneto-optical recording media loaded into a read/write device.

At least one network interface 13 provides a connection between the device 1 and a phase modulator of a signal connected to an antenna of the array of antennas.

FIG. 14 shows the device 1 connected to a phase modulator MP of an antenna of the array of antennas. The phase modulator MP then provides a modulated radio signal S_{RF}(Φₙ), the value of the applied phase and amplitude modulation having been calculated according to one of the embodiments of the methods covered by the development.

The development further relates to a method of forming a composite beam via linear combination of orthogonal beams of an array of radio-communication antennas, the method comprising the following steps implemented by a device intended to receive a radio signal, referred to as radio signal, whose energy is focused according to the composite beam:
estimating, for at least one sub-carrier of a frequency band used to transport the radio signal, a propagation channel of the radio signal by means of data collected during a sweeping of the set of orthogonal beams of the array of antennas,
determining a broadband covariance matrix of a multicarrier propagation channel of the radio signal from the at least one estimated propagation channel,
selecting an eigenvector of said broadband covariance matrix associated with an eigenvalue of said strongest broadband covariance matrix, a component of the selected eigenvector, referred to as weighting vector, corresponding to a weighting coefficient associated with a beam of the array of antennas,
determining parameters relating to phase and amplitude modulation coefficients intended to be applied to at least one signal corresponding to a radio signal processed by at least one antenna of the array of antennas on the basis of the values of the components of the weighting factor.

In one embodiment of the method for forming covered by the development, the propagation channel being estimated by means of data collected during a sweeping of the set of orthogonal beams of the array of antennas of a device transmitting the radio signal for at least one sub-carrier of a frequency band used to transport the radio signal, the method further comprises:
a step of transmitting, to the device transmitting the radio signal, a message comprising said parameters relating to phase and amplitude modulation coefficients, referred to as feedback message.

In this embodiment, the method for forming a composite beam comprises, prior to the step of transmitting said feedback message, the following steps:
creating a subset of beams comprising at least one beam selected from the set of orthogonal beams of the array of antennas,
selecting a weighting vector relating to said subset of beams from a reduced broadband covariance matrix, a component of the weighting vector relating to said subset of beams corresponding to a weighting coefficient associated with a beam of the subset of beams,
determining the values of the components of a quantized weighting vector, said values of the components of said quantized weighting vector being obtained by rounding a value of a modulus and a value of an argument of the components of said weighting vector relating to said subset of beams to at least one possible state defined by a number of quantization bits used to encode the amplitude and phase values.
generating said feedback message, said parameters relating to phase and amplitude modulation coefficients comprising identifiers of the beams comprised in said subset of beams and said values of the components of the quantized weighting vector.

In this embodiment, the subset of beams comprises the beams for which a reception power of the radio signal is the highest.

In this embodiment, the method for forming a composite beam the subset of beams comprises the beams for which a modulus of the corresponding component of the weighting vector relating to said subset of beams is the highest.

In this embodiment, the step of creating the subset of beams comprises the following steps:
selecting at least one beam f, from the set of N orthogonal beams formed by the array of antennas, for which a reception power of the received radio signal is the highest,
as a function of a number L of orthogonal beams to combine to form the composite beam, determining (N−1) reduced broadband covariance matrices of dimensions L×L, a reduced broadband covariance matrix corresponding to a combination of the beam f with (L−1) beams selected from the remaining (N−1) beams,
determining the eigenvalues of the (N−1) reduced broadband covariance matrices,
selecting (L−1) beams for which an eigenvalue of the reduced broadband covariance matrix is the highest.
In another embodiment, the method for forming a composite beam further comprises:
prior to said step of estimating, for at least one sub-carrier of a frequency band used to transport the radio signal, the transmission channel of the radio signal, a step of sweeping the set of orthogonal beams of the array of antennas of the receiving device of the radio signal,
a step of modulating said at least one signal corresponding to a radio signal processed by at least one antenna of the array of antennas of the receiving device of the radio signal by means of said parameters relating to phase and amplitude modulation coefficients determined on the basis of the values of the components of the weighting vector.

The development also relates to a device configured to form a composite beam via linear combination of orthogonal beams from an array of radio-communication antennas, the device comprising means for:
receiving a radio signal, referred to as radio signal, whose energy is focused according to the composite beam,
estimating, for at least one sub-carrier of a frequency band used to transport the radio signal, a propagation channel of the radio signal by means of data collected during a sweeping of the set of orthogonal beams of the array of antennas,
determining a broadband covariance matrix of a multicarrier propagation channel of the radio signal from the at least one estimated propagation channel,
selecting an eigenvector of said broadband covariance matrix associated with an eigenvalue of said strongest broadband covariance matrix, a component of the selected eigenvector, referred to as weighting vector, corresponding to a weighting coefficient associated with a beam of the array of antennas,
determining parameters relating to phase and amplitude modulation coefficients intended to be applied to at least one signal corresponding to a radio signal processed by at least one antenna of the array of antennas on the basis of the values of the components of the weighting factor.

The development further relates to a communication device comprising at least one device configured to form a composite beam via linear combination of orthogonal beams from an array of radio-communication antennas, the device comprising means for:
receiving a radio signal, referred to as radio signal, whose energy is focused according to the composite beam,
estimating, for at least one sub-carrier of a frequency band used to transport the radio signal, a propagation channel of the radio signal by means of data collected during a sweeping of the set of orthogonal beams of the array of antennas,
determining a broadband covariance matrix of a multicarrier propagation channel of the radio signal from the at least one estimated propagation channel,
selecting an eigenvector of said broadband covariance matrix associated with an eigenvalue of said strongest broadband covariance matrix, a component of the selected eigenvector, referred to as weighting vector, corresponding to a weighting coefficient associated with a beam of the array of antennas,
determining parameters relating to phase and amplitude modulation coefficients intended to be applied to at least one signal corresponding to a radio signal processed by at least one antenna of the array of antennas on the basis of the values of the components of the weighting factor.

In a particular implementation, the communication device further comprises:
said array of radio-communication antennas,
means for sweeping, for at least one sub-carrier of a frequency band used to transport the radio signal, the set of orthogonal beams of the array of antennas of the communication device, and
means for modulating said at least one signal corresponding to the radio signal processed by at least one antenna of said array of antennas of said communication device by means of said parameters relating to phase and amplitude modulation coefficients determined on the basis of the values of the components of the weighting vector.

The purpose of the development is also a method for generating a composite beam via linear combination of orthogonal beams of an array of antennas of a communication device, said method being implemented by the communication device and comprising the following steps:
sweeping, for at least one sub-carrier of a frequency band used to transport the radio signal, the set of orthogonal beams of the array of antennas of the communication device,
transmitting data collected during the sweeping of the set of orthogonal beams to a device intended to receive a radio signal transmitted by the communication device, whose energy is focused according to the composite beam,
receiving a message transmitted by the device intended to receive the radio signal, said message comprising parameters relating to phase and amplitude modulation coefficients intended to be applied to at least one signal corresponding to a radio signal processed by at least one antenna of the array of radio-communication antennas, said modulation coefficients being determined according to values of the components of an eigenvector of a broadband covariance matrix of a propagation channel of the radio signal estimated by means of the data collected during the sweeping of the set of orthogonal beams, said eigenvector being associated with an eigenvalue of said strongest broadband covariance matrix, a component of the eigenvector constituting a weighting coefficient associated with a beam of the array of antennas,
modulating said at least one signal corresponding to the radio signal processed by at least one antenna of said array of antennas by means of said parameters relating to radio phase and amplitude modulation coefficients.

A further object of the development is a communication device configured to generate a composite beam via linear combination of orthogonal beams from an array of antennas of said communication device, the communication device comprising means for:
sweeping, for at least one sub-carrier of a frequency band used to transport the radio signal, the set of orthogonal beams of the array of antennas of the communication device,
transmitting data collected during the sweeping of the set of orthogonal beams to a device intended to receive a radio signal transmitted by the communication device, whose energy is focused according to the composite beam,
receiving a message transmitted by a device intended to receive a radio signal transmitted by said base station, referred to as radio signal, whose energy is focused according to the composite beam, said message comprising parameters relating to phase and amplitude modulation coefficients intended to be applied to at least one signal corresponding to a radio signal processed by at least one antenna of the array of radio-communication antennas, said modulation coefficients being determined according to values of the components of an eigenvector of a broadband covariance matrix of a propagation channel of the radio signal estimated by means of the data collected during the sweeping of the set of orthogonal beams, said eigenvector being associated with an eigenvalue of said strongest broadband covariance matrix, a component of the eigenvector constituting a weighting coefficient associated with a beam of the array of antennas,
modulating said at least one signal corresponding to the radio signal processed by at least one antenna of said array of antennas by means of said parameters relating to received phase and amplitude modulation coefficients.

1. A method of forming a composite beam via linear combination of orthogonal beams of an array of antennas belonging to a transmitting device intended to transmit a radio signal whose energy is focused according to the composite beam, the method comprising the following implemented by a receiving device receiving the radio signal:
estimating, for at least one sub-carrier of a frequency band used to transport the radio signal, a propagation channel of the radio signal based on data collected during a sweeping of the set of orthogonal beams of the array of antennas carried out by the transmitting device,
determining the coefficients of a broadband covariance matrix from the at least one estimated propagation channel,
selecting an eigenvector of the broadband covariance matrix associated with a highest eigenvalue of the broadband covariance matrix, a component of the selected eigenvector, known as weighting vector, corresponding to a weighting coefficient associated with a beam of the array of antennas,
determining parameters relating to phase and amplitude modulation coefficients intended to be applied to at least one signal processed in transmission by at least one antenna of the array of antennas corresponding to the radio signal on the basis of the values of the components of the weighting vector, and
transmitting, to the transmitting device, a message comprising the parameters relating to the phase and amplitude modulation coefficients, referred to as feedback message.

2. The method of forming a composite beam according to claim 1, comprising prior to the step of transmitting the feedback message, the following:
creating a subset of beams comprising at least one beam selected from the set of orthogonal beams of the array of antennas,
selecting a weighting vector relating to the subset of beams from a reduced broadband covariance matrix, a component of the weighting vector relating to the subset of beams corresponding to a weighting coefficient associated with a beam of the subset of beams,
determining the values of the components of a quantized weighting vector, the values of the components of the quantized weighting vector being obtained by rounding a value of a modulus and a value of an argument of the components of the weighting vector relating to the subset of beams to at least one possible state defined by a number of quantization bits used to encode the amplitude and phase values, and
generating the feedback message, the parameters relating to phase and amplitude modulation coefficients comprising identifiers of the beams included in the subset of beams and the values of the components of the quantized weighting vector.

3. The method of forming a composite beam according to claim 2, wherein the subset of beams comprises the beams for which a reception power of the radio signal is the highest.

4. The method of forming a composite beam according to claim 2, wherein the subset of beams comprises the beams for which a modulus of the corresponding component of the weighting vector relating to the subset of beams is the highest.

5. The method of forming a composite beam according to claim 2, wherein creating the subset of beams comprises the following:
a) selecting at least one beam f, from the set of N orthogonal beams formed by the array of antennas, for which a reception power of the radio signal is the highest,
b) determining (N−1) reduced broadband covariance matrices of dimensions 2×2, one reduced broadband covariance matrix of dimensions 2×2 corresponding to a combination of beam f with one of the remaining (N−1) beams,
c) determining the eigenvalues for the set of (N−1) reduced broadband covariance matrices of dimensions 2×2,
d) selecting, from the (N−1) remaining beams, a second beam f′ corresponding to the eigenvalue of the strongest reduced broadband covariance matrix of dimensions 2×2, and
e) acts b) to d) being repeated until a number L of beams are selected to form the subset of beams by increasing by one, at each iteration, the dimensions of the reduced broadband covariance matrix and by decreasing by one, at each iteration, the number of reduced broadband covariance matrices and the number of remaining beams.

6. A first device configured to obtain the forming of a composite beam via linear combination of orthogonal beams from an array of antennas belonging to a transmit device intended to transmit a radio signal whose energy is focused according to the composite beam, the first device comprising at least a processor configured to:
receive the radio signal,
estimate, for at least one sub-carrier of a frequency band used to transport the radio signal, a propagation channel of the radio signal based on data collected during a sweeping of the set of orthogonal beams of the array of antennas carried out by the transmit device,
determine coefficients of a broadband covariance matrix from the at least one estimated propagation channel,
select an eigenvector of the broadband covariance matrix associated with a highest eigenvalue of the broadband covariance matrix, a component of the selected eigenvector, referred to as weighting vector, corresponding to a weighting coefficient associated with a beam of the array of antennas,
determine parameters relating to phase and amplitude modulation coefficients intended to be applied to at least one signal processed in transmission by at least one antenna of the array of antennas corresponding to the radio signal on the basis of the values of the components of the weighting vector, and
transmit, to the transmitting device, a message comprising the parameters relating to the phase and amplitude modulation coefficients.

7. A communication device comprising at least one first device configured to obtain the forming of a composite beam via linear combination of orthogonal beams from an array of antennas belonging to a transmit device intended to transmit a radio signal whose energy is focused according to the composite beam, the first device comprising at least a processor configured to:
receive the radio signal,
estimate, for at least one sub-carrier of a frequency band used to transport the radio signal, a propagation channel of the radio signal based on data collected during a sweeping of the set of orthogonal beams of the array of antennas carried out by the transmit device,
determine coefficients of a broadband covariance matrix from the at least one estimated propagation channel,
select an eigenvector of the broadband covariance matrix associated with a highest eigenvalue of the broadband covariance matrix, a component of the selected eigenvector, referred to as a weighting vector, corresponding to a weighting coefficient associated with a beam of the array of antennas,
determine parameters relating to phase and amplitude modulation coefficients intended to be applied to at least one signal processed in transmission by at least one antenna of the array of antennas corresponding to the radio signal on the basis of the values of the components of the weighting vector, and
transmit, to the transmit device, a message comprising the parameters relating to the phase and amplitude modulation coefficients.

8. A method of generating a composite beam via linear combination of orthogonal beams of an array of antennas belonging to a transmitting device intended to transmit a radio signal whose energy is focused according to the composite beam, the method being implemented by the transmitting device and comprising:
sweeping, for at least one sub-carrier of a frequency band used to transport the radio signal, the set of orthogonal beams of the array of antennas,
transmitting data collected during the sweeping of the set of orthogonal beams to a receiving device intended to receive the radio signal,
receiving a message transmitted by the receiving device, the message comprising parameters relating to phase and amplitude modulation coefficients intended to be applied to at least one signal processed in transmission by at least one antenna of the array of antennas corresponding to the radio signal, the modulation coefficients being determined according to values of the components of an eigenvector of a broadband covariance matrix, the coefficients of which are determined on the basis of an estimate of a propagation channel obtained based on the data collected during the sweeping of the set of orthogonal beams, the eigenvector being associated with a highest eigenvalue of the broadband covariance matrix, a component of the eigenvector constituting a weighting coefficient associated with a beam of the array of antennas, and
modulating the at least one signal processed in transmission by at least one antenna of the array of antennas corresponding to the radio signal by means of the parameters relating to received phase and amplitude modulation coefficients.

9. A communication device configured to generate a composite beam via linear combination of orthogonal beams of an array of antennas belonging to the communication device, the communication device intended to transmit a radio signal whose energy is focused according to the composite beam, the communication device comprising at least a processor configured to:
sweep, for at least one sub-carrier of a frequency band used to transport the radio signal, the set of orthogonal beams of the array of antennas,
transmit data collected during the sweeping of the set of orthogonal beams to a receiving device intended to receive the radio signal,
receive a message transmitted by the receiving device, the message comprising parameters relating to phase and amplitude modulation coefficients intended to be applied to at least one signal processed in transmission by at least one antenna of the array of antennas corresponding to the radio signal, the modulation coefficients being determined according to values of the components of an eigenvector of a broadband covariance matrix, the coefficients of which are determined on the basis of an estimate of a propagation channel obtained based on the data collected during the sweeping of the set of orthogonal beams, the eigenvector being associated with a highest eigenvalue of the broadband covariance matrix, a component of the eigenvector constituting a weighting coefficient associated with a beam of the array of antennas, and
modulate the at least one signal processed in transmission by at least one antenna of the array of antennas corresponding to the radio signal based on the parameters relating to received phase and amplitude modulation coefficients.

10. A processing circuit comprising a processor and a non-transitory memory, the non-transitory memory storing program code instructions of a computer program for implementing the method for forming a composite beam according to claim 1, when the computer program is executed by the processor.

11. Computer A processing circuit comprising a processor and a non-transitory memory, the non-transitory memory storing program code instructions of a computer program for implementing the method for generating a composite beam according to claim 8, when the computer program is executed by the processor.
